(19) United States
(12) Patent Application Publication
(10) Pub. No.: US 2026/0169524 A1
(43) Pub. Date: Jun. 18, 2026

(54) WEARABLE DEVICE, SYSTEM, AND METHOD FOR CONTROLLING WEARABLE DEVICE

(71) Applicant: SOLOS TECHNOLOGY (SHENZHEN) LIMITED, Shenzhen (CN)

(72) Inventors: Hoi Man Lau, Shenzhen (CN); Kwok Wah Law, Shenzhen (CN); Wai Kuen Kenny Cheung, Shenzhen (CN)

(21) Appl. No.: 19/383,741

(22) Filed: Nov. 9, 2025

Related U.S. Application Data
(63) Continuation of application No. PCT/CN2024/090705, filed on Apr. 29, 2024.

(30) Foreign Application Priority Data
May 8, 2023 (CN) 202310508975.4

(51) Int. Cl. G06F 1/16; G01C 19/56; G01P 15/18; G06F 18/241

(52) U.S. Cl. CPC G06F 1/163; G01C 19/56; G01P 15/18; G06F 18/241

(57) ABSTRACT

Wearable device, system, and method for controlling wearable device are disclosed. The wearable device includes a processor and an inertial sensor. The processor is connected to the inertial sensor and is configured to acquire dynamic data of a user's action through the inertial sensor (12), classify the user's action according to the dynamic data, determine a specified action corresponding to the user's action by comparing the dynamic data with a preset specified action template based on an action type, and control the wearable device to execute a corresponding functional operation according to the specified action and the working state of the wearable device. The wearable device, system, and method for controlling wearable device can improve the diversity and intelligence of the automatic control of the wearable device.

### CROSS-REFERENCE TO RELATED APPLICATIONS

The present application is a Continuation Application of PCT Application No. PCT/CN2024/090705, filed on Apr. 29, 2024, which claims the priority of Chinese Patent Application No. CN202310508975.4, entitled “Wearable Device, System, and Method for Controlling Wearable Device” and filed on May 8, 2023, the entire contents of which are hereby incorporated by reference.

### TECHNICAL FIELD

The present disclosure relates to the technical field of wearable devices, and in particular, to a wearable device, system, and method for controlling wearable device.

### BACKGROUND

Automatic control enables a controlled wearable device to switch functions without user's direct instructions. Automatic control can seamlessly adjust functions in response to user activities, greatly improving user experience. For example, proximity sensors on Bluetooth headsets continuously measure the distance between an obstacle and the sensor using sensors such as infrared distance measuring sensors. Whenever the user wears the headset, the user's cheek and ear are close to the headset surface, and the distance between the obstacle (user) and the sensor (headset) remains short. When the measured distance increases, it is determined that the headset is not worn, and the playback and on/off states of the headset can be automatically controlled according to whether the headset is worn.

However, infrared distance measuring sensors in existing wearable devices often only make a single judgment on the usage state, resulting in a single control method and insufficient intelligence.

### SUMMARY

Embodiments of the present disclosure provide a wearable device, system, and method for controlling wearable device, which can solve the problems of a single control method and insufficient intelligence of wearable devices.

On one aspect, an embodiment of the present disclosure provides a wearable device, including:
a processor and an inertial sensor;
the processor is connected to the inertial sensor, and is configured to acquire dynamic data of a user's action through the inertial sensor, classify the user's action according to the dynamic data, determine a specified action corresponding to the user's action by comparing the dynamic data with a preset specified action template based on an action type, and control the wearable device to execute a corresponding functional operation according to the specified action and a working state of the wearable device.

On another aspect, an embodiment of the present disclosure further provides a wearable device system, including: an intelligent terminal, a cloud server, and the wearable device as described above.

On another aspect, an embodiment of the present disclosure further provides a wearable device control method, including: implementing automatic control through the wearable device as described above.

As can be seen from the foregoing embodiments of the present disclosure, the wearable device includes a processor and an inertial sensor. Dynamic data of a user's action is acquired through the inertial sensor, the user's action is classified according to the dynamic data, a specified action corresponding to the user's action is determined by comparing the dynamic data with a preset specified action template based on the action type, and the wearable device is controlled to execute a corresponding functional operation according to the specified action and the working state of the wearable device. Diverse controls can be correspondingly performed according to different user actions by analyzing whether the user's action is a specified action and combining the specified action with the usage state of the wearable device, thereby improving the intelligence and diversity of the control of the wearable device.

### BRIEF DESCRIPTION OF DRAWINGS

To clearly illustrate the technical solutions in the embodiments of the present disclosure, the following briefly introduces the accompanying drawings required for describing the embodiments or the prior art. Obviously, the accompanying drawings in the following description are only some embodiments of the present disclosure.

FIG. 1 is a schematic structural view of smart glasses provided by an embodiment of the present disclosure;

FIG. 2 is a schematic hardware structure view of smart glasses provided by an embodiment of the present disclosure;

FIG. 3 is a schematic flowchart of a smart glass control method in an embodiment of the present disclosure;

FIG. 4 is a schematic implementation flowchart of a wearable device control method provided by an embodiment of the present disclosure;

FIG. 5 is a schematic structural view of a smart glass system provided by an embodiment of the present disclosure.

### DESCRIPTION OF EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. Obviously, the described embodiments are part of the embodiments of the present disclosure, rather than all of them. Based on the embodiments in the present disclosure, all other embodiments obtained by those skilled in the art without creative efforts shall fall within the protection scope of the present disclosure.

The embodiment of the present disclosure provides a wearable device, which can not only determine the user's rapid actions in a short time, such as folding glass temples and removing glasses, but also determine the user's continuous background activities, such as running, walking, going up and down stairs, etc., and combine with the device usage state, such as music playback state, to make automatic control judgments matching the user's activities, such as pausing or playing music, turning on/off the machine, etc. Diverse controls can be correspondingly performed according to different user dynamics and various usage states of the wearable device by the user. In the following embodiments, the wearable device is taken as an example of smart glasses. In addition, the wearable device also includes other wearable and portable devices directly worn on the body or integrated into the user's clothes or accessories, such as smart helmets, smart watches, smart bracelets, etc.

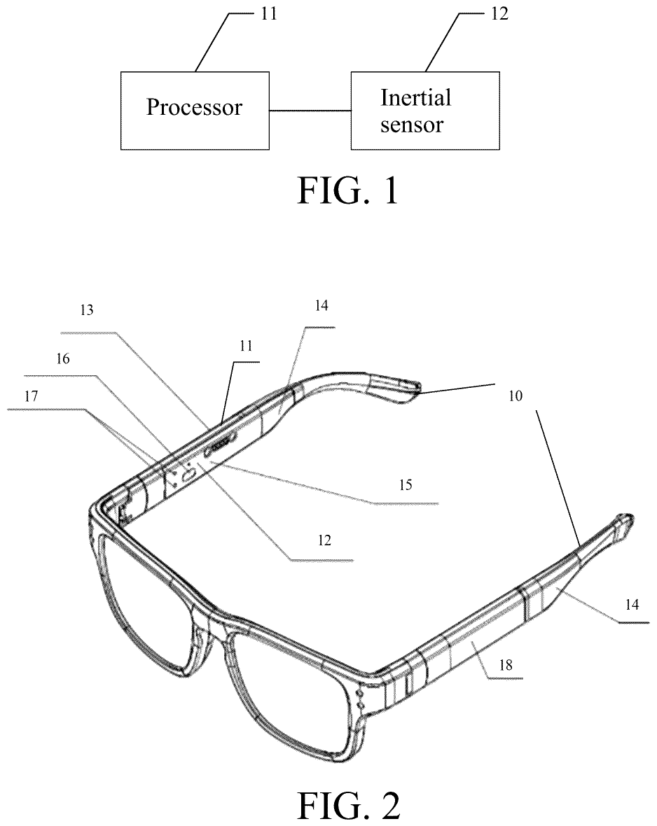

Referring to FIG. 1 and FIG. 2, FIG. 1 is a schematic structural view of smart glasses provided by an embodiment of the present disclosure, and FIG. 2 is a schematic hardware structure diagram of smart glasses provided by an embodiment of the present disclosure. For ease of description, only the parts related to the embodiment of the present disclosure are shown. The smart glasses may include a processor 11 and an inertial sensor 12. The processor 11 and the inertial sensor 12 may be disposed in the temple 10, and the processor 11 is connected to the inertial sensor 12. The inertial sensor 12 includes a three-axis acceleration sensor and a three-axis gyroscope.

The processor 11 is configured to acquire dynamic data of a user's action through the inertial sensor 12, classify the user's action according to the dynamic data, determine a specified action corresponding to the user's action by comparing the dynamic data with a preset specified action template based on an action type obtained after classification, and control the wearable device to execute a functional operation corresponding to the specified action and the working state of the wearable device according to the specified action and the working state of the wearable device.

The processor 11 continuously acquires dynamic data of the user's action, and makes a user behavior judgment based on a short time period, where the short time period is, for example, one second or two seconds, which is preset in the processor 11.

The dynamic data includes acceleration measured by the three-axis acceleration sensor and angular velocity measured by the three-axis gyroscope in the inertial sensor 12. The processor 11 continuously collects acceleration and angular velocity data of the wearable device.

The dynamic data is classified into a static state and a dynamic state according to the absolute magnitudes of acceleration and angular velocity. The processor 11 is further configured to calculate an absolute change amount of the acceleration within a preset time period or an absolute change amount of the angular velocity within the preset time period; when the absolute change amount of the acceleration within the preset time period is less than a first threshold, or the absolute change amount of the angular velocity within the preset time period is less than a second threshold, determine that the user's action is of a static state type; when the absolute change amount of the acceleration within the preset time period is greater than the first threshold, or the absolute change amount of the angular velocity within the preset time period is greater than the second threshold, determine that the user's action is of a dynamic state type.

The static state refers to a state where the user's head movement amplitude is small. The change amplitude of the head movement is judged through the absolute changes of acceleration and angular velocity. When the change amplitude of the head movement is less than the change amplitude threshold of the head movement when walking normally, it is determined that the user is in a static state, such as taking a car, chatting, having a meeting, eating, reading, using a mobile phone, etc. The dynamic state refers to a state where the user's head movement amplitude is large. The change amplitude of the head movement is judged through the absolute changes of acceleration and angular velocity. When the change amplitude of the head movement is greater than the change amplitude threshold of the head movement when walking normally, it is determined that the user is in a dynamic state, such as running, walking, going up and down stairs, etc.

The processor 11 is further configured to, when the user's action is of the static state type, determine that the specified action corresponding to the user's action is a static state or an idle state (i.e., the user does not perform any action) by comparing the similarity between the acceleration or the angular velocity and a first specified action template. The first specified template includes an idle action template, and an idle similarity threshold is set in the idle action template. Specifically, the processor 11 is further configured to calculate a Euclidean distance between the acceleration or the angular velocity and the idle action template; when the Euclidean distance is greater than a preset idle similarity threshold in the idle action template, determine that the user's action is the static state; when the Euclidean distance is less than the preset idle similarity threshold in the idle action template, determine that the user's action is the idle state.

On the other hand, when the user's action is of the dynamic state type, the user's action is classified into specified action categories by comparing the direction of the acceleration or the angular velocity with preset specified action category conditions, and coarse filtering is performed to determine the approximate activity direction of the user's action.

For the user's action belonging to the wearable device operation category, the specified action corresponding to the user's action is determined to be an operation state or a dynamic state of the wearable device by comparing the similarity between the acceleration or the angular velocity of the user's action and a second specified action template. The wearable device operation state may include operation states such as removing the wearable device, wearing the wearable device, and folding the wearable device.

The second specified action template is a wearable device operation action template, which may be one or more. When there are multiple templates, it may include four templates: a wearable device removal operation action template, a wearable device wearing operation action template, a wearable device folding operation action template, etc.; when there is one template, the above four templates may be integrated. Corresponding similarity thresholds are set in the wearable device operation action templates, and the similarity thresholds may include a wearable device removal similarity threshold, a wearable device wearing similarity threshold, and a wearable device folding similarity threshold.

Further, the processor 11 is further configured to compare the direction of the acceleration or the angular velocity with preset specified action category conditions; when the direction of the acceleration or the angular velocity meets a wearable device removal category condition, determine that the specified action category of the user's action is a wearable device removal category; when the direction of the acceleration or the angular velocity meets a wearable device wearing category condition, determine that the specified action category of the user's action is a wearable device wearing category; when the direction of the acceleration or the angular velocity meets a wearable device folding category condition, determine that the specified action category of the user's action is a wearable device folding category; when the direction of the acceleration or the angular velocity does not meet the wearable device removal category condition, the wearable device wearing category condition, or the wearable device folding category condition, determine that the user's action is a dynamic state.

The direction or magnitude of the user's action has common points: for example, when folding glasses, the glass temples are folded inward due to the structure of the glasses, so the direction of acceleration and angular velocity can only be inward; the way of removing glasses is usually to slightly move them downward from the horizontal line, while wearing glasses is to move them upward from below to the line of sight. Therefore, whether the dynamic data belongs to the specified action category can be divided according to the common points in direction and magnitude.

The processor 11 is further configured to calculate a Euclidean distance between the acceleration or the angular velocity and the wearable device operation action template; when the Euclidean distance is less than the wearable device removal similarity threshold in the wearable device operation action template, determine that the user's action is wearable device removal; when the Euclidean distance is less than the wearable device wearing similarity threshold in the wearable device operation action template, determine that the user's action is wearable device wearing; when the Euclidean distance is less than the wearable device folding similarity threshold in the wearable device operation action template, determine that the user's action is wearable device folding; when the Euclidean distance is greater than the wearable device removal similarity threshold, the wearable device wearing similarity threshold, and the wearable device folding similarity threshold, confirm that the specified action corresponding to the user's action is a dynamic state.

The specific calculation method for calculating the Euclidean distance d(μᵢ, x) between the acceleration or the angular velocity and the idle action template or the wearable device operation action template is as follows:

$$d ( {μ}_{i} , x ) = \sqrt{{\sum }_{t = 0}^{n} {( {μ}_{i} ( t ) - x ( t ) )}^{2}} where$$

$${μ}_{i} ( t ) = \frac{1}{\vert {S}_{i} \vert} {\sum }_{x ∈ {S}_{i}} x ( t )$$

where x (t) is the acceleration or angular velocity, S={S₁, S₂, S₃, . . . , Sₖ} is a category data set of specified actions, where S₁˜Sₖ represent different categories; μᵢ(t) is the idle action template or the wearable device operation action template.

After classifying the user's action into specified action categories, the similarity between the dynamic data of the user's action and the above action templates is further compared, and whether the user's action is a specified action is judged according to the dynamic data. The action templates are obtained by collecting wearable device operations, and specifically, daily dynamic data of actions such as removing glasses, wearing glasses, and folding glasses can be clustered to obtain class centroids of specified actions, and each class centroid becomes the action template of the action.

Euclidean distance is a measure of similarity. This embodiment compares the Euclidean distance between dynamic data and action templates to judge the similarity between the user's action and the action templates, thereby determining whether the user's action belongs to a specified action.

Dynamic data of the user's daily activity actions (such as walking, going up and down stairs, sitting down, running, etc.) is collected in advance, and the Euclidean distances between the dynamic data of these actions and each template are compared. Then, clustering analysis is performed using Euclidean distances to find the classification boundary between daily activity actions and specified actions, and then the similarity threshold is calculated in conjunction with the trade-off between sensitivity and specificity.

The above-mentioned coarse-to-fine approach is used to determine the corresponding specified action for the user's action. The specified actions are removing glasses, wearing glasses, folding glasses, idling, etc., which can increase calculation speed and reduce power consumption.

The processor 11 is further configured to determine an automatic control condition corresponding to the specified action according to the specified action corresponding to the user's action, and control the wearable device to execute a corresponding operation according to the automatic control condition and the current working state of the wearable device.

The operation may be real-time or delayed function control, such as shutting down, turning on, pausing, stopping, or playing music.

The processor 11 is further configured to, when the automatic control condition corresponding to the specified action is a music playback state and the current working state of the smart glasses is music playback, control the music playback state according to the specified action; when the automatic control condition corresponding to the specified action is controlling the on/off state and the current working state of the smart glasses is a power-on or power-off state, control the on/off of the smart glasses according to the specified action; the specified actions corresponding to the user's actions are removing glasses, wearing glasses, or folding glasses; the automatic control conditions include controlling the music playback state and controlling the on/off state; the music playback state includes pausing, stopping, or playing music; the on/off control includes turning on or off the machine.

Function control includes control of the wearable device itself and control of other electronic devices wirelessly connected via Bluetooth, WIFI, etc.

Specifically, the processor 11 is further configured to control the smart glasses to play music when it is determined that the user's action is wearing the smart glasses and the working state of the smart glasses is a non-music playing state; control the smart glasses to stop playing music when it is determined that the user's action is removing the smart glasses and the working state of the smart glasses is a music playing state; control the smart glasses to shut down immediately when it is determined that the user's action is folding the smart glass temples and the working state of the smart glasses is a power-on state; control the smart glasses to shut down immediately when it is determined that the user's action is placing the smart glasses in a forward direction, the placement duration reaches a first duration, and the working state of the smart glasses is a power-on state; control the smart glasses to shut down immediately when it is determined that the user's action is placing the smart glasses in a reverse direction, the placement duration reaches a second duration, and the working state of the smart glasses is a power-on state, wherein the first duration is greater than the second duration.

The judgment of the forward or reverse placement of the smart glasses can be realized through sensors in the smart glasses. The processor acquires data collected by the sensors and judges the placement direction of the glasses through these sensor data. The specific sensors are not limited, as long as the collected data enables the processor to judge the forward or reverse placement of the smart glasses.

For example, the specified action is removing glasses, and the corresponding automatic control condition is stopping music playback. When the user's action is determined to be removing glasses and the smart glasses are currently playing music A, the processor controls the player to stop playing music A.

Another example: the specified action is folding glasses, and the corresponding automatic control condition is shutting down. When the user's action is determined to be folding glasses and the smart glasses are currently in a non-working state, the processor controls the smart glasses to shut down.

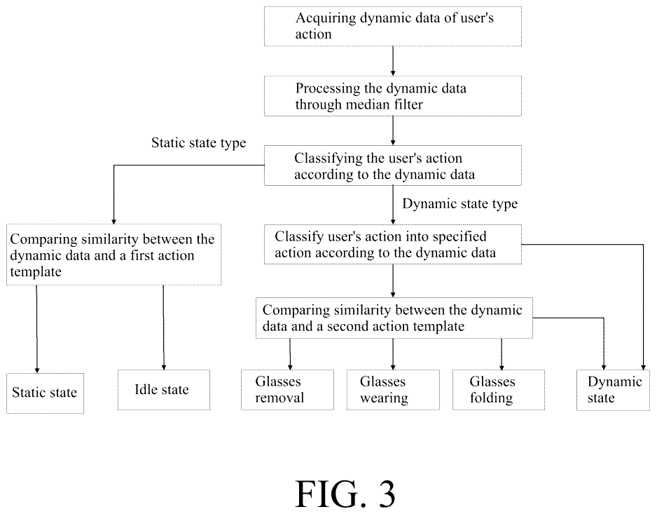

Referring to FIG. 3, FIG. 3 is a schematic flowchart of the specific process of the control method processed by the above processor, where the wearable device is taken as an example of smart glasses.

Continuing to refer to FIG. 2, the smart glasses further include: an input device 13, a playback device 14, a first wireless data transmission module 15, a proximity sensor 16, a microphone 17, and a battery 18.

The input device 13 includes a touch control device, and the preset input operation corresponds to a touch operation; the input device 13 further includes keys, and the preset input operation corresponds to a key pressing operation.

The playback device 14 may specifically be a speaker.

A first wireless data transmission module 15 is further disposed in the temple 10 of the smart glasses, and is used for wirelessly connecting the smart glasses to an intelligent terminal having a second wireless data transmission module. The intelligent terminal may be an electronic device such as a mobile phone, a smart watch, a tablet computer, or a desktop computer.

In this embodiment, the wearable device includes a processor and an inertial sensor. Dynamic data of a user's action is acquired through the inertial sensor, the user's action is classified according to the dynamic data, a specified action corresponding to the user's action is determined by comparing the dynamic data with a preset specified action template based on an action type, and the wearable device is controlled to execute a corresponding functional operation according to the specified action and the working state of the wearable device. Diverse controls can be correspondingly performed according to different user actions by analyzing whether the user's action is a specified action and combining the specified action with the usage state of the wearable device, thereby improving the intelligence and diversity of the control of the wearable device.

An embodiment of the present disclosure further provides a wearable device control method, which implements automatic control through the wearable device as described above.

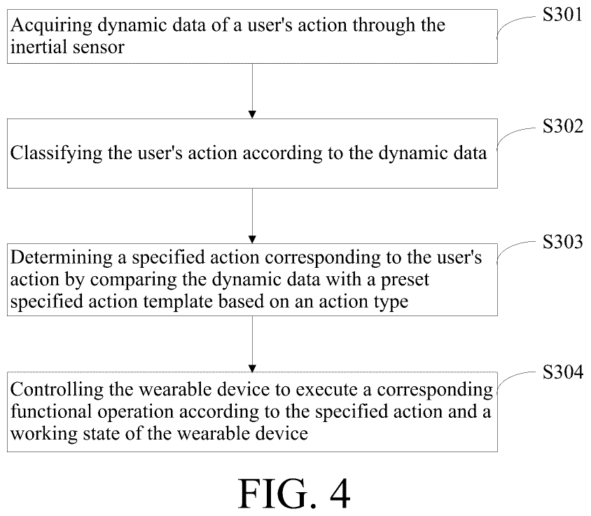

Referring to FIG. 4, FIG. 4 is a schematic implementation flowchart of the wearable device control method, which includes:
S301. Acquiring dynamic data of a user's action through an inertial sensor. The inertial sensor may include a three-axis acceleration sensor and a three-axis gyroscope. The dynamic data includes acceleration measured by the three-axis acceleration sensor and angular velocity measured by the three-axis gyroscope.
S302. Classifying the user's action according to the dynamic data. Calculate an absolute change amount of the acceleration within a preset time period or an absolute change amount of the angular velocity within the preset time period; when the absolute change amount of the acceleration is less than a first threshold, or when the absolute change amount of the angular velocity is less than a second threshold, determine that the user's action is of a static state type; when the absolute change amount of the acceleration is greater than the first threshold, or when the absolute change amount of the angular velocity is greater than the second threshold, determine that the user's action is of a dynamic state type.
S303. Determining a specified action corresponding to the user's action by comparing the dynamic data with a preset specified action template based on an action type. When the user's action is of the static state type, determine that the specified action corresponding to the user's action is a static state or an idle state by comparing the similarity between the acceleration or the angular velocity and a first specified action template; when the user's action is of the dynamic state type, classify the user's action into specified action categories by comparing the direction of the acceleration or the angular velocity with preset specified action category conditions, and for the user's action belonging to a wearable device operation category, determine that the specified action corresponding to the user's action is a wearable device operation state or a dynamic state by comparing the similarity between the acceleration or the angular velocity of the user's action and a second specified action template.

The step of classifying the user's action into specified action categories by comparing the direction of the acceleration or the angular velocity with preset specified action category conditions includes:
Comparing the direction of the acceleration or the angular velocity with preset specified action category conditions;
When the direction of the acceleration or the angular velocity meets a wearable device removal category condition, determining that the specified action category of the user's action is a wearable device removal category; when the direction of the acceleration or the angular velocity meets a wearable device wearing category condition, determining that the specified action category of the user's action is a wearable device wearing category; when the direction of the acceleration or the angular velocity meets a wearable device folding category condition, determining that the specified action category of the user's action is a wearable device folding category; when the direction of the acceleration or the angular velocity does not meet the wearable device removal category condition, the wearable device wearing category condition, or the wearable device folding category condition, determining that the user's action is a dynamic state.

The step of determining that the specified action corresponding to the user's action is a static state or an idle state by comparing the similarity between the acceleration or the angular velocity and the first specified action template includes:
Calculating a Euclidean distance between the acceleration or the angular velocity and an idle action template;
Determining that the user's action is the static state when the Euclidean distance is less than an idle similarity threshold in the idle action template;
Determine that the user's action is the idle state when the Euclidean distance is greater than the idle similarity threshold in the idle action template.

The step of determining that the specified action corresponding to the user's action is a wearable device operation state or a dynamic state by comparing the similarity between the dynamic data and the second specified action template includes:

Calculating a Euclidean distance between the acceleration or the angular velocity and a wearable device operation action template; determining that the user's action is wearable device removal when the Euclidean distance is less than a wearable device removal similarity threshold in the wearable device operation action template; determining that the user's action is wearable device wearing when the Euclidean distance is less than a wearable device wearing similarity threshold in the wearable device operation action template; determining that the user's action is wearable device folding when the Euclidean distance is less than a wearable device folding similarity threshold in the wearable device operation action template; determining that the specified action corresponding to the user's action is a dynamic state when the Euclidean distance is greater than the wearable device removal similarity threshold, the wearable device wearing similarity threshold, and the wearable device folding similarity threshold.
S304. Controlling the wearable device to execute a corresponding functional operation according to the specified action and the working state of the wearable device.

Determine an automatic control condition corresponding to the specified action according to the specified action corresponding to the user's action; control the wearable device to execute a corresponding operation according to the automatic control condition and the current working state of the wearable device.

For specific content in the embodiment of the present disclosure, refer to the description of the foregoing embodiments.

In the embodiment of the present disclosure, dynamic data of a user's action is acquired through an inertial sensor, the user's action is classified according to the dynamic data, a specified action corresponding to the user's action is determined by comparing the dynamic data with a preset specified action template based on the action type, and the wearable device is controlled to execute a corresponding functional operation according to the specified action and the working state of the wearable device. Diverse controls can be correspondingly performed according to different user actions by analyzing whether the user's action is a specified action and combining the specified action with the usage state of the wearable device, thereby improving the intelligence and diversity of the control of the wearable device.

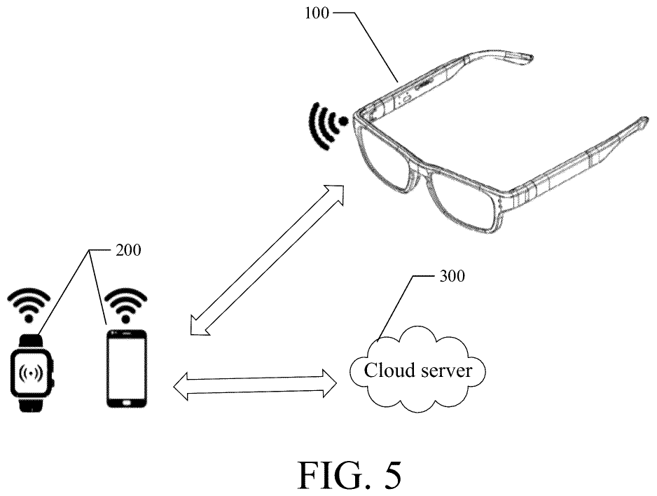

Referring to FIG. 5, an embodiment of the present disclosure further provides a wearable device system, including a wearable device 100, an intelligent terminal 200, and a cloud server 300; the wearable device may be the smart glasses in the above embodiment, the intelligent terminal 200 is the intelligent terminal in the above embodiment, an application program runs on the intelligent terminal 200, and the cloud server 300 may store data and application programs.

The wearable device 100 is connected to the intelligent terminal 200 through a wireless network, and the intelligent terminal 200 is connected to the cloud server 300 through a wireless network or a mobile network.

The wireless network includes Bluetooth, WIFI, etc.; the mobile network includes 4G or 5G, etc.

The wearable device 100 acquires data of application programs set by the user on the intelligent terminal 200 through the wireless network.

The intelligent terminal 200 exchanges data with the cloud server 300 through the wireless network, such as downloading application programs, uploading setting data of the wearable device to the cloud server 300, etc.

It should be noted that, for the sake of concise description, the foregoing method embodiments are all expressed as a series of action combinations. However, those skilled in the art should know that the present disclosure is not limited by the described action sequence, because according to the present disclosure, some steps can be performed in other sequences or simultaneously. Secondly, those skilled in the art should also know that the embodiments described in the specification are all preferred embodiments, and the actions and modules involved are not necessarily required by the present disclosure.

In the above embodiments, the description of each embodiment focuses on different aspects. For parts not described in detail in a certain embodiment, reference may be made to relevant descriptions of other embodiments.

The above is a description of the wearable device, the wearable device system, and the wearable device control method provided by the present disclosure. For those skilled in the art, according to the idea of the embodiments of the present disclosure, there will be changes in the specific implementation and application scope. In summary, the content of this specification should not be construed as limiting the present disclosure.

What is claimed is:

1. A wearable device, wherein:
the wearable device comprises a processor and an inertial sensor; and
the processor is connected to the inertial sensor, and is configured to acquire dynamic data of a user's action through the inertial sensor, classify the user's action according to the dynamic data, determine a specified action corresponding to the user's action by comparing the dynamic data with a preset specified action template based on an action type, and control the wearable device to execute a corresponding functional operation according to the specified action and a working state of the wearable device.

2. The wearable device according to claim 1, wherein the inertial sensor comprises a three-axis acceleration sensor and a three-axis gyroscope; and
the dynamic data comprises acceleration measured by the three-axis acceleration sensor and angular velocity measured by the three-axis gyroscope.

3. The wearable device according to claim 2, wherein the processor is further configured to calculate an absolute change amount of the acceleration within a preset time period or an absolute change amount of the angular velocity within a preset time period;
determine that the user's action is of a static state type when the absolute change amount of the acceleration is less than a first threshold, or when the absolute change amount of the angular velocity is less than a second threshold; and
determine that the user's action is of a dynamic state type when the absolute change amount of the acceleration is greater than the first threshold, or when the absolute change amount of the angular velocity is greater than the second threshold.

4. The wearable device according to claim 3, wherein the processor is further configured to:
when the user's action is of the static state type, determine that the specified action corresponding to the user's action is a static state or an idle state by comparing a similarity between the acceleration or the angular velocity and a first specified action template;
when the user's action is of the dynamic state type, classify the user's action into specified action categories by comparing a direction of the acceleration or the angular velocity with preset specified action category conditions, and
for the user's action belonging to a wearable device operation category, determine that the specified action corresponding to the user's action is an operation state or a dynamic state of the wearable device by comparing a similarity between the acceleration or the angular velocity of the user's action and a second specified action template.

5. The wearable device according to claim 4, wherein the processor is further configured to:
compare the direction of the acceleration or the angular velocity with the preset specified action category conditions;
when the direction of the acceleration or the angular velocity meets a wearable device removal category condition, determine that the specified action category of the user's action is a wearable device removal category;
when the direction of the acceleration or the angular velocity meets a wearable device wearing category condition, determine that the specified action category of the user's action is a wearable device wearing category;
when the direction of the acceleration or the angular velocity meets a wearable device folding category condition, determine that the specified action category of the user's action is a wearable device folding category; and
when the direction of the acceleration or the angular velocity does not meet the wearable device removal category condition, the wearable device wearing category condition, or the wearable device folding category condition, determine that the user's action is a dynamic state.

6. The wearable device according to claim 1, wherein the processor is further configured to calculate a Euclidean distance between the acceleration or the angular velocity and an idle action template;
when the Euclidean distance is greater than an idle similarity threshold in the idle action template, determine that the user's action is the static state; and
when the Euclidean distance is less than the idle similarity threshold in the idle action template, determine that the user's action is the idle state.

7. The wearable device according to claim 5, wherein the processor is further configured to calculate a Euclidean distance between the acceleration or the angular velocity and a wearable device operation action template;
when the Euclidean distance is less than a wearable device removal similarity threshold in the wearable device operation action template, determine that the user's action is wearable device removal;
when the Euclidean distance is less than a wearable device wearing similarity threshold in the wearable device operation action template, determine that the user's action is wearable device wearing;
when the Euclidean distance is less than a wearable device folding similarity threshold in the wearable device operation action template, determine that the user's action is wearable device folding; and
when the Euclidean distance is greater than the wearable device removal similarity threshold, the wearable device wearing similarity threshold, and the wearable device folding similarity threshold, determine that the specified action corresponding to the user's action is a dynamic state.

8. The wearable device according to claim 7, wherein the processor is further configured to determine an automatic control condition corresponding to the specified action according to the specified action corresponding to the user's action, and control the wearable device to execute a corresponding operation according to the automatic control condition and the current working state of the wearable device.

9. The wearable device according to claim 8, wherein the wearable device is smart glasses, and the processor is further configured to:
control the smart glasses to play music when it is determined that the user's action is wearing the smart glasses and the working state of the smart glasses is a non-music playing state;
control the smart glasses to stop playing music when it is determined that the user's action is removing the smart glasses and the working state of the smart glasses is a music playing state;
control the smart glasses to shut down immediately when it is determined that the user's action is folding the smart glass temples and the working state of the smart glasses is a power-on state;
control the smart glasses to shut down immediately when it is determined that the user's action is placing the smart glasses in a forward direction, the placement duration reaches a first duration, and the working state of the smart glasses is a power-on state; and
control the smart glasses to shut down immediately when it is determined that the user's action is placing the smart glasses in a reverse direction, the placement duration reaches a second duration, and the working state of the smart glasses is a power-on state, wherein the first duration is greater than the second duration.

10. A wearable device system, wherein the system comprises: an intelligent terminal (200), a cloud server (300), and the wearable device according to claim 1.

11. A wearable device control method, wherein the wearable device comprises a processor and an inertial sensor; the control method comprises:
acquiring dynamic data of a user's action through the inertial sensor; and
the processor classifying the user's action according to the dynamic data, determining a specified action corresponding to the user's action by comparing the dynamic data with a preset specified action template based on an action type; and controlling the wearable device to execute a corresponding functional operation according to the specified action and a working state of the wearable device.

12. The wearable device control method according to claim 11, wherein the inertial sensor comprises a three-axis acceleration sensor and a three-axis gyroscope; the dynamic data comprises acceleration measured by the three-axis acceleration sensor and angular velocity measured by the three-axis gyroscope;
the control method further comprises:
the processor calculating an absolute change amount of the acceleration within a preset time period or an absolute change amount of the angular velocity within a preset time period;
determining that the user's action is of a static state type when the absolute change amount of the acceleration is less than a first threshold, or when the absolute change amount of the angular velocity is less than a second threshold, and
determining that the user's action is of a dynamic state type when the absolute change amount of the acceleration is greater than the first threshold, or when the absolute change amount of angular velocity is greater than the second threshold.

13. The wearable device control method according to claim 12, wherein the control method further comprises:
when the user's action is of the static state type, the processor determining that the specified action corresponding to the user's action is a static state or an idle state by comparing the similarity between the acceleration or the angular velocity and a first specified action template;
when the user's action is of the dynamic state type, the processor classifying the user's action into specified action categories by comparing a direction of the acceleration or the angular velocity with preset specified action category conditions, and
for the user's action belonging to a wearable device operation category, determining that the specified action corresponding to the user's action is a wearable device operation state or a dynamic state by comparing the similarity between the acceleration or the angular velocity of the user's action and a second specified action template.

14. The wearable device control method according to claim 13, wherein the control method further comprises:
the processor comparing the direction of the acceleration or the angular velocity with the preset specified action category conditions;
when the direction of the acceleration or the angular velocity meets a wearable device removal category condition, the processor determining that the specified action category of the user's action is a wearable device removal category;
when the direction of the acceleration or the angular velocity meets a wearable device wearing category condition, the processor determining that the specified action category of the user's action is a wearable device wearing category;
when the direction of the acceleration or the angular velocity meets a wearable device folding category condition, the processor determining that the specified action category of the user's action is a wearable device folding category; and
when the direction of the acceleration or the angular velocity does not meet the wearable device removal category condition, the wearable device wearing category condition, or the wearable device folding category condition, the processor determining that the user's action is a dynamic state.

15. The wearable device control method according to claim 11, wherein the control method further comprises:
the processor calculating a Euclidean distance between the acceleration or the angular velocity and an idle action template;
when the Euclidean distance is greater than an idle similarity threshold in the idle action template, the processor determining that the user's action is the static state; and
when the Euclidean distance is less than the idle similarity threshold in the idle action template, the processor determining that the user's action is the idle state.

16. The wearable device control method according to claim 14, wherein the control method further comprises:
the processor calculating a Euclidean distance between the acceleration or the angular velocity and a wearable device operation action template;
when the Euclidean distance is less than a wearable device removal similarity threshold in the wearable device operation action template, the processor determining that the user's action is wearable device removal;
when the Euclidean distance is less than a wearable device wearing similarity threshold in the wearable device operation action template, the processor determining that the user's action is wearable device wearing;
when the Euclidean distance is less than a wearable device folding similarity threshold in the wearable device operation action template, the processor determining that the user's action is wearable device folding; and
when the Euclidean distance is greater than the wearable device removal similarity threshold, the wearable device wearing similarity threshold, and the wearable device folding similarity threshold, the processor determining that the specified action corresponding to the user's action is a dynamic state.

17. The wearable device control method according to claim 16, wherein the control method further comprises:
the processor determining an automatic control condition corresponding to the specified action according to the specified action corresponding to the user's action; and
the processor controlling the wearable device to execute a corresponding operation according to the automatic control condition and the current working state of the wearable device.

18. The wearable device control method according to claim 17, wherein the wearable device is smart glasses; the control method further comprises:
when it is determined that the user's action is wearing the smart glasses and the working state of the smart glasses is a non-music playing state, the processor controlling the smart glasses to play music;
when it is determined that the user's action is removing the smart glasses and the working state of the smart glasses is a music playing state, the processor controlling the smart glasses to stop playing music;
when it is determined that the user's action is folding the smart glass temples and the working state of the smart glasses is a power-on state, the processor controlling the smart glasses to shut down immediately;
when it is determined that the user's action is placing the smart glasses in a forward direction, the placement duration reaches a first duration, and the working state of the smart glasses is a power-on state, the processor controlling the smart glasses to shut down immediately; and
when it is determined that the user's action is placing the smart glasses in a reverse direction, the placement duration reaches a second duration, and the working state of the smart glasses is a power-on state, the processor controlling the smart glasses to shut down immediately, wherein the first duration is greater than the second duration.
